(19) United States
(12) Patent Application Publication
(10) Pub. No.: US 2006/0148496 A1
(43) Pub. Date: Jul. 6, 2006

(54) Method for administrating SMS message of mobile phone

(75) Inventors: Yuan-Bo Zhu, Taipei (TW); Tony Tsai, Taipei (TW); David Ho, Taipei (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: Inventec Appliances Corp.

(21) Appl. No.: 11/177,561

(22) Filed: Jul. 8, 2005

(30) Foreign Application Priority Data
Dec. 30, 2004 (TW) 093141505

(51) Int. Cl. H04Q 7/20

(52) U.S. Cl. 455/466; 455/418

(57) ABSTRACT

A method for administrating SMS message of mobile phone is disclosed, The method comprises the steps of receiving an SMS message;. analyzing the sender ID; determining whether the sender ID matches with the lists set by the user on the guard function; if the sender ID is matched, the receive/instant-delete function will be check whether it is initiated; if it is initiated, the received SMS message will be deleted instantly without display; if it is not initiated, informing the new SMS message to the user by the vibration of mobile phone and sending the received SMS message directly to the spam SMS message file; if the sender ID is not matched, displaying the received new SMS message. The present invention utilizes a multi-layer type SMS-message guard function to abate various SMS-message nuisances and provides a simple administration interface, easiness of operation, and convenience of receiving for the user.

### BACKGROUND OF THE INVENTION

1. Field of the Invention

The present invention relates to a method for administrating Short Message Service (SMS) message of mobile phone, particularly to a method for anti spam SMS messages.

2. Description of the Related Art

The SMS of mobile phone has advantages of convenience, rapidity, and low cost. Via SMS messages, users can exchange information with each other, such as regards between relatives or friends, promotion information of business, etc. Owing to the characteristics of timeliness, wide range application, low transmission cost, and no message loss even mobile phone turn-off, SMS becomes one of fast-growing businesses in wireless telecommunication field.

With the flood of SMS messages, many variant SMS messages also appear, such as fraud messages, sexual messages, advertising messages, and even rumor messages, and those become potential crises in our society. Especially, as more and more primary and junior high school students own mobile phones now, the problem of variant SMS messages might harm the child's mind and need to be seriously concerned by the people.

For solving those variant SMS message problems, a Japanese telecommunication company NTT DoCoMo spent twenty-seven billion Japanese Yen to construct a system, which enables mobile phone users to set sender identification (ID) on their mobile phone by themselves so that senders without being set are unable to send any SMS message to them. The company also provides mobile phone users with the functions of not only receiving the SMS message from specified senders but also limiting the quantity of daily SMS messages. However, as the users can only receive the SMS messages from the specified senders and wouldn't receive SMS messages from other non-specified senders, the users will be unable to receive some important SMS messages in some special conditions. For example, if a user's friend has changed his/her phone number, he/she can not directly inform the user of his/her new phone number via a SMS message.

If a method, which has functions of refusing SMS message sender phone number setting, SMS message storing period setting, and periodical SMS message deleting setting, can be invented, the mobile phone users will be able to instantly delete spam SMS messages and will not lose any important message.

### SUMMARY OF THE INVENTION

In the aforementioned problem, the object of this invention is to provide a method for administrating SMS message of mobile phone, which can solve the problem of nuisance SMS messages, provide automatic message deletion and administration of SMS message, and promote convenience of receiving SMS message.

To achieve the aforementioned object, the present invention provides a method for administrating SMS message of mobile phone comprising the steps of receiving a SMS message with a sender ID; analyzing and identifying of the sender ID; determining whether the sender matches with the lists set on the guard function; if they are matched, checking whether the receive/instant-delete function is initiated; if it is initiated, the received SMS message will not be displayed and deleted immediately; if it is not initiated, informing the new SMS message to the user by vibration of mobile phone and sending the received SMS message to the spam SMS message file; if they are not matched, displaying the received new SMS message.

In summary, the present invention provides a method for SMS messages of mobile phone, wherein a guard function of SMS message is further added to the conventional administration function of SMS message, and the guard function of SMS message can perform the settings of blacklist, refusing text receiving, receiving the message only from the sender on the phonebook and message receiving, and thereby, the present invention can abate various SMS nuisances and provides a simple administration interface and easiness of operation for the user.

### BRIEF DESCRIPTION OF THE DRAWINGS

To enable the aforementioned objective, characteristics, and advantages of the present invention to be more easily understood, a preferred embodiment is described in detail below in cooperation with the attached drawings.

FIG. 1 shows schematically the SMS message guard function menu of the method for administrating SMS message of mobile phone of the present invention;

FIG. 2 shows schematically entering the sender's phone number of read or unread SMS messages into the blacklist for administrating SMS message of mobile phone of the present invention; and

FIG. 3 shows the process flowchart of the method for administrating SMS message of mobile phone of the present invention.

### DETAILED DESCRIPTION OF THE INVENTION

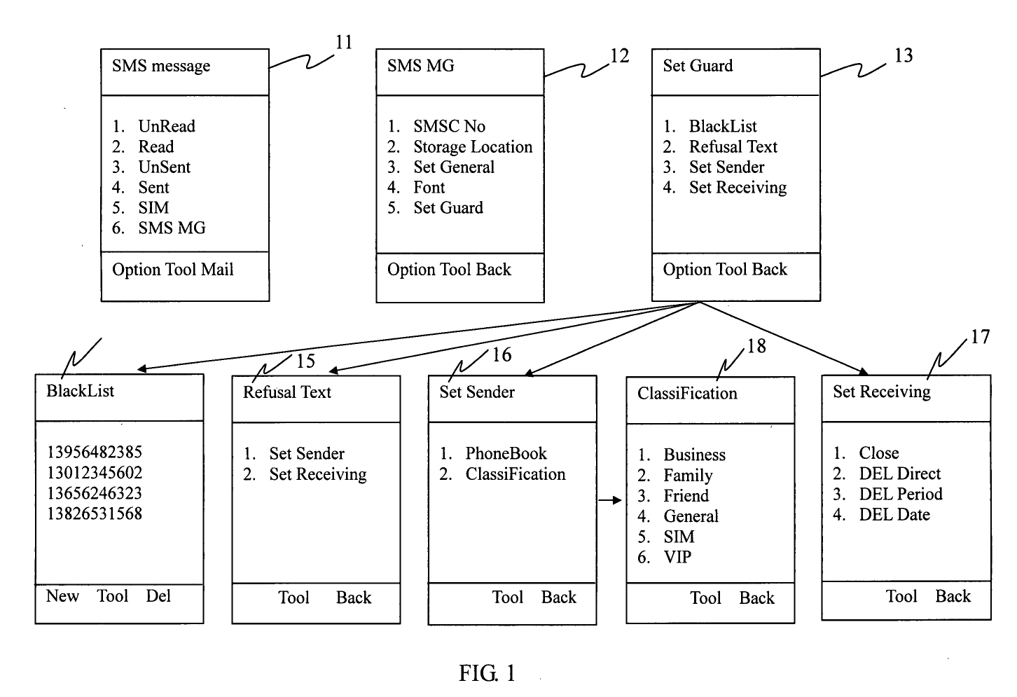

Refer to FIG. 1, which shows schematically the guard function menu of the present invention. The SMS message administration submenu 11 has menu items which comprise unread SMS message (UnRead), read SMS message (Read), unsent SMS message (UnSent), sent SMS message (Sent), Subscriber Identity Module message (SIM), and SMS message guard (SMS MG). The SMS message setting (Set SMS) submenu 12 comprises menu items which comprise SMS center number (SMSC No.), SMS message storage location (Storage Location), general setting (Set General), font selection (Font), and SMS message guard setting (Set Guard). The user enters on the menu item of SMS message guard setting (Set Guard) and then enters into a SMS message guard submenu 13, which further comprises the following menu items: blacklist setting (BlackList), refusing text receiving setting (Refusal Text), receiving the message only from the sender on the phonebook (Set Sender), and message receiving setting (Set Receiving). On the BlackList 14, the user can set phone numbers for refusing receiving SMS messages from those senders. The Refusal-Text 15 includes setting items for refusal texts set in the mobile phone originally (Phone Refusal) and set by the user (User Refusal). The Set Sender 16 comprises the select items for receiving the SMS message from the phonebook (PhoneBook) and from classified SMS messages group (ClassiFication). The ClassiFication 18 comprises the items such as business message (Business), family message (Family), friend message (Friend), message of Subscriber Identity Module message (SIM), VIP message (VIP), and general message (General). The Set Receiving 17 comprises the select items such as close (Close), delete direct (DEL Direct), delete periodical (DEL Period), delete at the specified date by the user (DEL DATE). Via the multiple functions of BlackList 14, Refusal Text 15, Set Sender 16, and Set Receiving 17 provided by the SMS message guard of this invention, the nuisance SMS messages can be securely isolated.

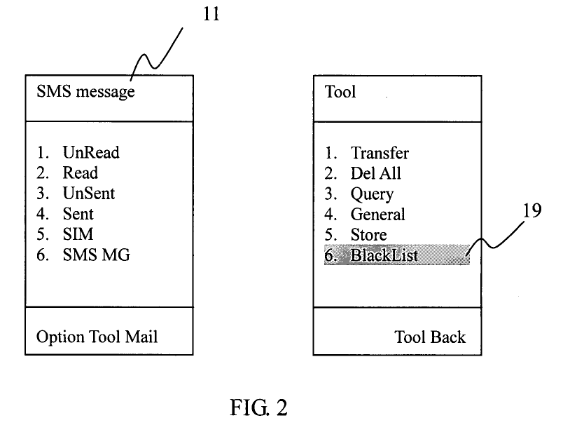

Refer to FIG. 2, which shows schematically entering the sender's phone number of read or unread SMS messages into the BlackList. After receiving a SMS message, the user can set the sender's phone number to the BlackList 19 to avoid the sender's sending message again.

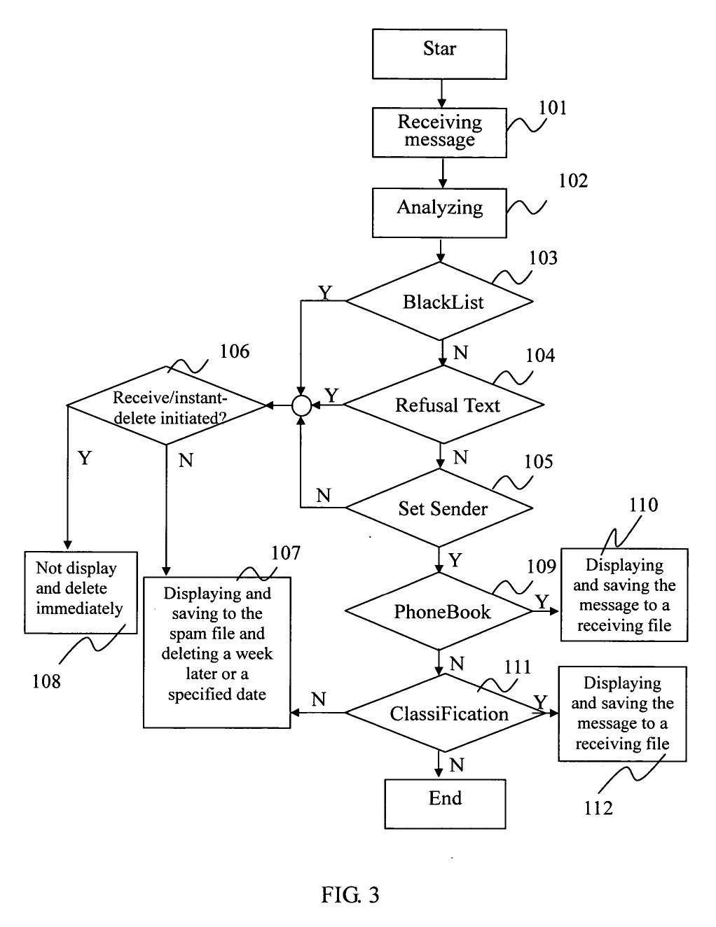

Refer to FIG. 3, which shows the process flowchart of the method for administrating SMS message of mobile phone of the present invention. Firstly, a user receives an SMS message with a sender ID (S101), and then, the received SMS message will be analyzed by SMS message guard (S102). After analyzing, SMS message guard can determine whether the sender ID matches with the list set on the BlackList (S103). If the sender ID matches with the list on the BlackList, the receive/instant-delete function will be check whether the function is initiated (S106). If the receive/instant-delete function is initiated, the received message will not be displayed and be immediately deleted from the flash memory by microprocessor (S108). If the receive/instant-delete function is not initiated, the received message will be displayed and informed to the user by vibration of the mobile phone. Besides, the received message will be saved to a spam SMS message file and will be deleted a week later or at the date specified by the user (S107). If the sender ID does not match with the list on the BlackList, then the sender ID will be continued to match with the list stored on the Refusal-Text (S104). If the sender ID matches with the list on the Refusal-Text, the received message will be proceeded the same as from S106 to S108. If the sender ID does not match with the list on the Refusal-Text, the received message will be continued to match with the list on the Set Sender (S105). If the sender ID does not match with the list on the Set Sender, the received message will be proceeded the same as from S106 to S108. If the sender matches with the list in the Set Sender; the sender ID will be continued to match with the list on the PhoneBook (S109) or it matches with the list on the ClassiFication (S111); the new received SMS message will be displayed and saved to a receiving file. (S110 and S112).

Accordingly, adding the SMS message guard in mobile phone of this invention not only can reduce the harassments of nuisance SMS messages but also can avoid the frauds from evil senders.

The present invention has been disclosed above via those preferred embodiments; however, it is not intended to limit the scope of the present invention. It is to be noted that any modification or variation made by the person skilled in the art should not depart from the spirit of the present invention and be included within the scope of the present invention, and that the scope of the present invention be dependent upon the claims appended below.

What is claimed is:

1. A method for administrating SMS message of mobile phone, which is by adding a SMS message guard function having a plurality of lists set by a user for matching with a received SMS message, comprises the following steps:
receiving a SMS message, wherein the SMS message includes a sender ID;
analyzing the SMS message and determining whether the sender ID matching with the lists on the SMS message guard function;
if matching, a receive/instant-delete function is checked for its initiating condition;
if the receive/instant-delete function is initiated, deleting the SMS message without display;
if the receive/instant-delete function is not initiated, informing the SMS message to the user by vibration of mobile phone and saving the SMS message to a spam SMS message file; and
if not matching, the SMS message will be displayed.

2. The method as claimed in claim 1, wherein the SMS message guard function further comprises blacklist setting, refusing text receiving setting, receiving message only allowed from phonebook setting, message receiving setting.

3. The method as claimed in claim 2, wherein the function of the receiving message only allowed from phonebook further comprises receiving the SMS message from the phonebook and receiving SMS message from the classified SMS message group.

4. The method as claimed in claim 3, wherein the receiving SMS message from classified SMS message group includes business message, family message, friend message, SIM message, VIP message, and general message.

5. The method as claimed in claim 2, wherein the message receiving setting includes close, delete direct, delete periodical, delete on a specified date.

6. The method as claimed in claim 1, wherein the step of if receive/instant-delete function is not initiated, informing the SMS message to the user by vibration of mobile phone and saving the SMS message to a spam SMS message file further comprises a step of delete periodical.
